(19) United States
(12) Patent Application Publication
(10) Pub. No.: US 2020/0079004 A1
(43) Pub. Date: Mar. 12, 2020

(54) PRODUCT HAVING MICROPATTERN AND PROCESS FOR PRODUCTION OF SAID PRODUCT

(71) Applicant: Stora Enso OYJ, Helsinki (FI)

(72) Inventors: Jari Räsänen, Imatra (FI); Ville Ribu, Lappeenranta (FI); Kimmo Nevalainen, Kotka (FI); Nina Miikki, Imatra (FI); Mari Hiltunen, Imatra (FI); Outi Kylliäinen, Imatra (FI); Mika Kainusalmi, Savitaipale (FI); Panu Tanninen, Rauha (FI)

(73) Assignee: Stora Enso OYJ, Helsinki (FI)

(21) Appl. No.: 16/469,805

(22) PCT Filed: Dec. 14, 2017
(86) PCT No.: PCT/IB2017/057937

§ 371 Date: Jun. 14, 2019

(30) Foreign Application Priority Data
Dec. 16, 2016 (SE) 1651656-9

(51) Int. Cl. B29C 59/04; B31F 1/07; B29C 48/08; B29C 59/02

(52) U.S. Cl. CPC B29C 59/046; B31F 1/07; B65D 1/28; B29C 59/022; B29C 48/08

(57) ABSTRACT

The present invention is in the technical field of packages, specifically surfaces of materials used for packages, and the manufacture thereof. According to the present invention, a micropattern is created on at least surface of a substrate, to obtain a material suitable for manufacturing packages.

### TECHNICAL FIELD

The present invention is in the technical field of packages, specifically surfaces of materials used for packages, and the manufacture thereof. According to the present invention, a micropattern is created on at least one surface of a substrate, to obtain a material suitable for use in the manufacturing of packages.

### BACKGROUND

Carbonated beverages (beer, soda etc.) have a tendency to foam when poured into paperboard cups.

US2003187170 discloses a process for producing nanostructured and microstructured polymer films. The films are to be used as self-cleaning surfaces for i.a. glazing systems for buildings, internal coating for silos, exterior coatings of cars etc.

WO2011147757 discloses super-hydrophobic and self-cleaning articles produced by imprinting exposed surfaces with fine-grained and/or amorphous metallic embossing dies to transfer a dual surface structure, including ultra-fine features less than or equal to 100 nm embedded in and overlaying a surface topography with macro-surface structures.

US2011318539 discloses a method for preparing a transparent film in which a cured layer having a micro protrusion and recess face structure is formed on the surface of a base material film.

WO0170416 discloses surfaces of objects, in particular containers for receiving liquid, comprising a surface which is extremely hydrophobic and that has a wetting angle with water of no less than 120 degrees and having elevations and indentations wherein the distance between the elevations is less than 5 micrometers and at least the tops of the elevations consist of a hydrophobic material.

SE7512107 discloses a method of making paper-plastic laminates.

An image transfer belt with controlled surface topography to improve toner release is disclosed in US2010/300604.

WO2014049518 discloses a method for manufacturing a polymer product with super- or highly hydrophobic characteristics having a pattern providing a Lotus effect, preferably in the form of a film.

DE102007049482 is directed to a device having a stamping arrangement mounted between a coil and a winding coil. The arrangement is formed by a master cylinder and a pressing cylinder.

Although there are several disclosures of materials, particularly films, having modified surfaces, problems associated with for example foaming of carbonated beverages when poured into e.g. cups have not adequately addressed. In addition, the need to improve the release properties of materials to be used in packages has also not been adequately addressed. Furthermore, there is a need for efficient production of these materials and packages.

### SUMMARY

It has been found that by providing a micropattern on a surface of a packaging material in accordance with the present invention, several advantages can be obtained. It has been found that the micropattern has an effect on runnability and surface friction of the substrate, which relate to material performance in package converting and filling lines.

It has also been found that micropatterned materials obtained according to the present invention have rapid release-properties i.e. features that release viscous products easily from material (or package) surfaces. Packages with treated inner surfaces can be emptied more easily and residues of the packaged product are not left on the package walls.

Furthermore, it has been found that the amount of foaming, for example of a carbonated beverage when poured into a cup, can be controlled or prevented entirely by providing a micropattern on the inner surface of a cup, or parts thereof. In addition, the sealability of the side seam or the rim roll (in a cup lidding process) of a cup can be improved with the use of micropatterns obtained according to the present invention.

More specifically, it has also been found that the micropattern can be created without having to completely melt the surface layer of the substrate concerned. In one embodiment of the present invention, the micopattern is created without heating the surface layer of the substrate, i.e. the micropattern is created at room temperature.

Thus, it is an object of the present disclosure to provide an improved process for manufacturing a material having a micropattern on its surface and being useful in the production of packages. The material produced and the uses thereof are also objects of the present invention.

Micropatterns can be created by physically treating the substrate surfaces. Physical treatment of the substrate is performed by applying force or pressure to the surface of the material on which the micropattern is to be created.

The term micropattern as used herein refers to a pattern on a surface which may be regular or irregular and wherein the depth of the grooves or height of the elevated areas is 1-100 μm, such as from 2 to 80 μm or from 2 to 50 μm. The shape and depth of the pattern depends on the application and targeted properties, but parallel grooves and blind holes with various periods and dimensions are typically utilized.

The term “non-melted state” as used herein refers to a state of a material wherein said material is essentially in solid form, although the material may have been softened by heating. However, the material concerned is in a state in which it is not a liquid. In one embodiment of the present invention, the material which is a “non-melted state” has not been heated, i.e. said material is present at ambient or room temperature.

The micropattern is provided on at least one surface of a substrate material for packages. The substrate can be for example a film, laminate, paper product or board. In one embodiment of the invention, the micropattern is only provided on one side of the substrate.

According to a first aspect of the present invention, there is provided a process for the production of a micropattern on a surface of a packaging material comprising the steps of:
a) providing a substrate on which the micropattern is to be created;
b) treating the substrate by subjecting said substrate to force or pressure, to create a micropattern; wherein said substrate is in a non-melted state when said substrate is treated by force or pressure to obtain said micropattern; and wherein said micropattern created on the substrate mirrors the micropattern of the surface exerting the force or pressure.

In one embodiment, the force or pressure is created by a pair of forming surfaces. In one embodiment, each forming surface is shaped as a cylinder or as a cone.

In one embodiment of the present invention, the micropattern is created using a pair of forming cylinders (rotation die, FIG. 1).

The packaging material having a micropattern on its surface according to the present invention can for example be a paper product, a board, a film or a laminate.

A further embodiment of the present invention is a product comprising said packaging material. For example, the packaging material according to the present invention can be used in the production of packages, including packages for liquids. In particular, the packaging material can be used in the production of cups or trays. In one embodiment of the present invention, said micropattern is created at least in the area that will form the bottom of said cup or tray. Said micropattern may thus form release markings in said area.

One embodiment of the present invention is a flexible package comprising the packaging material having a micropattern on its surface. A further embodiment of the invention is a rigid package comprising a film having a micropattern on its surface.

### BRIEF DESCRIPTION OF THE FIGURES

FIG. 1: micropattern forming die.

FIG. 2: micropattern roll alternatives.

### DETAILED DESCRIPTION

The substrate on which the micropattern is to be provided is manufactured using methods known in the art.

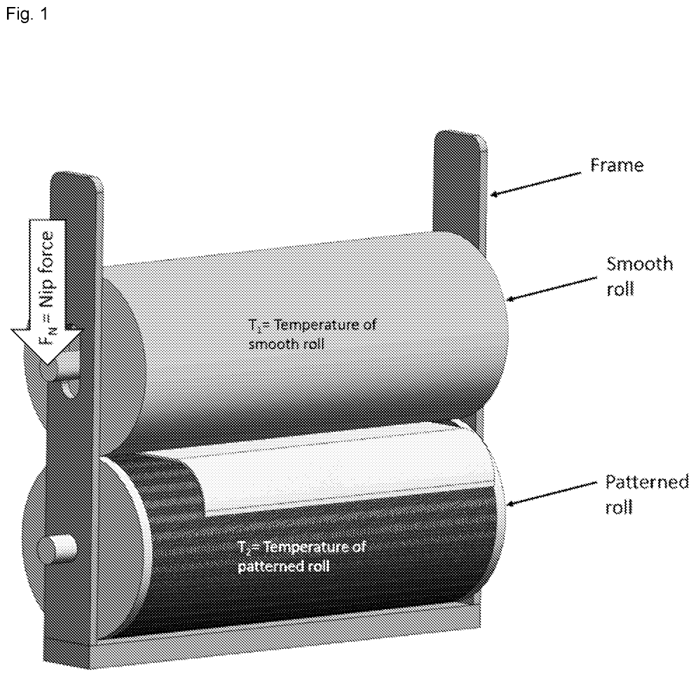

In one embodiment of the present invention, the micropattern is created using a pair of forming cylinders (rotation die, also referred to as forming die, FIG. 1).

The forming die typically includes a smooth roll and a patterned roll, both mounted on a frame (FIG. 1). The rotating rolls form a nip which the substrate to be treated passes through and the micropattern is transferred from the roll surface onto the substrate. The intensity of treatment is determined by the adjustable nip force (F_{N}) which is selected on basis of substrate material properties. The nip force is typically in the range of from 10 N/mm² to 30 N/m². Roll temperatures (T₁and T₂) can be adjusted to enhance the creation of micropatterns. For example, elevated roll temperatures cause softening of a polymer coating, thus making it more formable. Because of this, the nip force can be reduced to protect integrity of the base board onto which the micropattern is provided. However, the elevated temperatures are selected so that all parts of the substrate remain in a non-melted state. Typically, the elevated temperature is less than the glass transition temperature (T_{g}) of the surface polymer of the substrate. Thus, the entire substrate is in a non-melted state. Preferably, the polymer coating is softened by heating but not melted.

The diameters of the rolls can be increased to enlarge the area under pressure in the nip as necessary. The micropattern can also be created in multiple phases by placing several consecutive forming dies in a row. If micropatterns are desired on both sides of the material, both rolls of the forming die can be patterned. The smooth cylinder can also have a soft surface layer if the material to be micropatterned requires it.

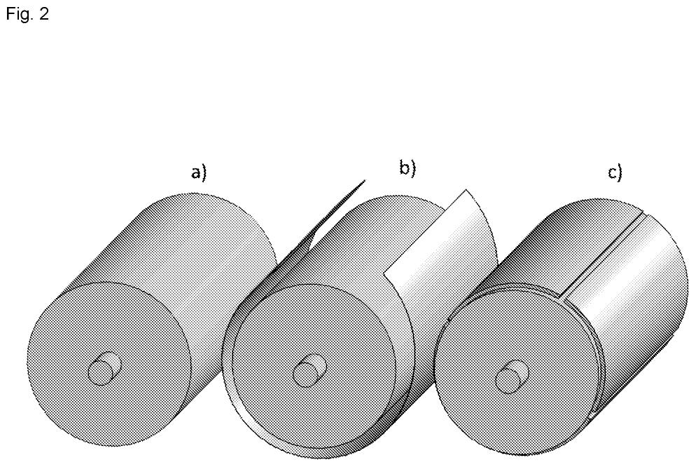

The micropattern can be provided on a roll in several different ways (FIG. 2). For example, the micropattern can be formed on the surface of the actual roll (a), on a steel plate that is wrapped around the roll (b) or on the segments that are clamped to the roll (c). Micropatterns can be created to the die surface using laser engraving, high precision machining and chemical milling. Also methods of additive manufacturing (AM) such as sintering and 3D-printing are suitable for the application.

The roll used to create the micropattern is typically in cylindrical form. Alternatively, the roll may have a conical shape which makes it applicable for example in the preparation of cupstock paperboard planks, which have curved shapes to be used in the cup-making process. Those conical rolls in nip will prepare, for example, line shaped surface micropatterns from bottom to top rim into the walls of a drinking cup. Due to the conical shape, the top rim circular length is greater than the bottom rim circular length. Therefore there will be a need to add extra micropatterned lines in to the top area of the cup planks to cover the entire surface in same surface density of patterns, equal to the bottom area. The blind spot type patterns or other non-directional (circular shape) micropatterns will fulfil all the patterned surface area without any geometrical positioned problems caused by the geometry of the paperboard planks.

The folding of a package may change the directions of micropatterned lines in the final packages if those lines are prepared only in the machine direction, i.e. as straight lines. To avoid this problem, circular micropatterns can be used, or there can be micropatterns in the surface area of the roll into the formation, that will prepare all the directed line-shaped micropatterns into the blanket in the right directions needed to ensure the material flow out of the final package in effective way. The right direction positioned micropattern line formations will help material release from the walls of the final package and flow easily out of the package through, for example, a pouring area or a hole created upon removal of a cap.

The process according to the present invention can for example be performed in the beginning of a blank feeding/material feeding step of a liquid packaging machine, a cup-making machine, a tray-forming machine or other 3-D forming device used for packaging material. In addition, the equipment required to carry out the process according to the present invention can arranged in close proximity to or even be integrated into other devices or machines such as off-coater lines, extrusion coating lines, paper machines and board machines etc. The process according to the present invention is scalable and can readily be adapted to existing processes and equipment used in the manufacture of packages.

In view of the above detailed description of the present invention, other modifications and variations will become apparent to those skilled in the art. However, it should be apparent that such other modifications and variations may be effected without departing from the spirit and scope of the invention.

1. A process for the production of a packaging material having a micropattern on at least one side of the material, the process comprising the steps of:
a) providing a substrate on which the micropattern is to be created; and,
b) treating the substrate by subjecting said substrate to force or pressure, to create a micropattern;
wherein said substrate is in a non-melted state when said substrate is treated by force or pressure to obtain said micropattern; and
wherein said micropattern created on the substrate mirrors the micropattern of the a surface exerting the force or pressure.

2. A process according to claim 1, wherein the force or pressure is created by a pair of forming surfaces.

3. A process according to claim 2, wherein each forming surface is shaped as a cylinder or as a cone.

4. A process according to claim 1, wherein the substrate is a paper product, a board, a film, or a laminate.

5. A process according to claim 1, wherein a temperature of said substrate in step b) is lower than a glass transition temperature of any polymer or polymers present on the surface of said substrate.

6. A process according to claim 1, wherein said micropattern is regular or irregular and wherein a depth of grooves or height of elevated areas of said micropattern is between 1-100 μm.

7. A process according to claim 1, wherein a surface of the substrate, on which the micropattern is created, has been softened by heating but is in a non-melted state when the micropattern is created.

8. A packaging material obtainable according to the process of claim 1.

9. A product manufactured from a packaging material according to claim 8.

10. A product according to claim 9, wherein said product is a package for liquids.

11. A product according to claim 9, wherein said product is a cup.

12. A product according to claim 9, wherein said product is a tray.
